(19) United States
(12) Patent Application Publication
(10) Pub. No.: US 2008/0063772 A1
(43) Pub. Date: Mar. 13, 2008

(54) CONCENTRATED FRESH BREWED TEA

(75) Inventors: Jonathan Kirschner, Powder Springs, GA (US); Charles Bradley Green, Lawrenceville, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 11/530,962

(22) Filed: Sep. 12, 2006

(51) Int. Cl. A23C 3/00

(52) U.S. Cl. 426/523

(57) ABSTRACT

A method of heating an amount of material positioned within a receptacle. The method may include heating a first volume of water to a predetermined temperature, pressurizing a first volume of steam to a predetermined pressure, releasing the first volume of steam towards the first volume of water so as to force the first volume of water into the receptacle, and heating the material within the receptacle.

### TECHNICAL FIELD

The present application relates generally to methods for brewing tea and more particularly relates to a method of brewing tea concentrate using saturated steam.

### BACKGROUND OF THE INVENTION

Numerous methods are known for providing tea and other types of steeped beverages. These methods range from traditional tea bags to the use of tea extracts and concentrates. The traditional tea bag can provide a high quality cup of tea but generally is not well suited for providing larger volumes of tea, at least not within a small amount of time. Tea extracts and concentrates can quickly provide larger volumes of tea and also may have an extended shelf life. The quality of the tea produced by such extracts and concentrates, however, often is not as high as that made from traditional tea bags.

There is a desire, therefore, for an improved method of brewing high quality tea in larger volumes and in smaller amounts of time than may be possible with the use of a traditional tea bag. The methods described herein preferably should produce a high quality and a high volume of tea in an efficient and cost effective manner.

### SUMMARY OF THE INVENTION

The present application thus describes a method of heating an amount of material positioned within a receptacle. The method may include heating a first volume of water to a predetermined temperature, pressurizing a first volume of steam to a predetermined pressure, releasing the first volume of steam towards the first volume of water so as to force the first volume of water into the receptacle, and heating the material within the receptacle.

The predetermined temperature may be about 200 to about 225 degrees Fahrenheit (about 93 to about 107 degrees Celsius). The predetermined pressure may be up to about 75 pounds per square inch (about 5.2 bar). The step of heating the material may take about ten (10) to about (15) seconds. The step of pressurizing the first volume of steam may include saturated steam. The step of releasing the first volume of steam towards the first volume of water so as to force the first volume of water into the receptacle may include forcing the first volume of water into the receptacle without reducing the temperature of the first volume of water.

The material may be tea leaves. About seven (7) grams of tea leaves are used so as to produce about one hundred (100) milliliters of tea. The step of heating the material may include brewing the tea leaves to a dilution ratio of about eight (8) to one (1) to about fifteen (15) to one (1). The method further may include adding dilution water to the tea and also presoaking the tea leaves with saturated steam.

The present application further provides a method of brewing tea leaves with a volume of water. The method may include the steps of warming the water to about 200 to about 225 degrees Fahrenheit (about 93 to about 107 degrees Celsius), forcing the water to the tea leaves at a pressure of up to about 75 pounds per square inch (about 5.2 bar), and brewing the tea leaves for about ten (10) to about (15) seconds.

The step of forcing the water may include providing saturated steam. About seven (7) grams of tea leaves are used so as to produce about one hundred (100) milliliters of tea. The step of brewing the tea leaves results in tea having a dilution ratio of about eight (8) to one (1) to about fifteen (15) to one (1). The method further may include adding dilution water to the tea and presoaking the tea leaves with saturated steam. The step of forcing the water may include pumping the water and pumping the water with a positive displacement pump. The step of forcing the water to the tea leaves may include forcing the water to the tea leaves without reducing the temperature of water.

The present application further describes a method of brewing an amount of tea leaves positioned within a tea receptacle. The method may include the steps of heating a first volume of water to about 210 degrees Fahrenheit (about 99 degrees Celsius), pressurizing a first volume of saturated steam to about 75 pounds per square inch (about 5.2 bar), releasing the first volume of saturated steam towards the first volume of water so as to force the first volume of water into the tea receptacle, and brewing the tea leaves within the tea receptacle for about ten (10) to about fifteen (15) seconds so as to produce tea with a dilution level of more than about eight (8) to one (1).

These and other features of the present application will become apparent to one of ordinary skill in the art upon review of the following detailed description when taken into conjunction with the several drawings and the appended claims.

### BRIEF DESCRIPTION OF THE DRAWINGS

FIG. 1 is a schematic view of a tea brewing device as is described herein.

FIG. 2 is a schematic view of an alternative device as is described herein.

FIG. 3 is a schematic view of an alternative device as is described herein.

### DETAILED DESCRIPTION

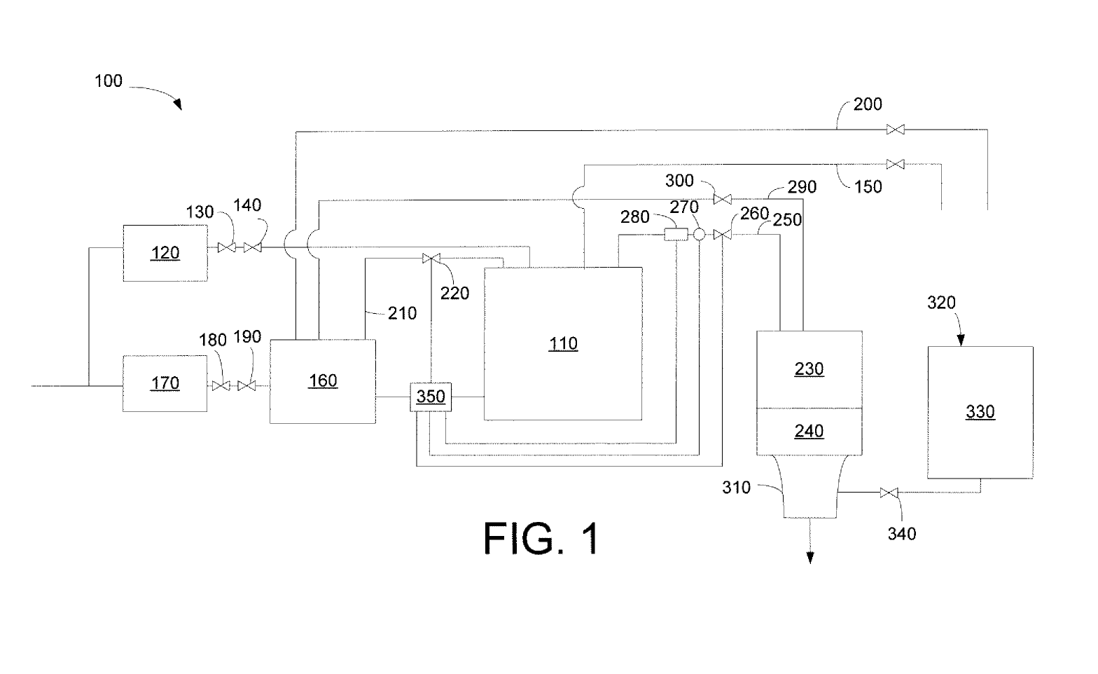

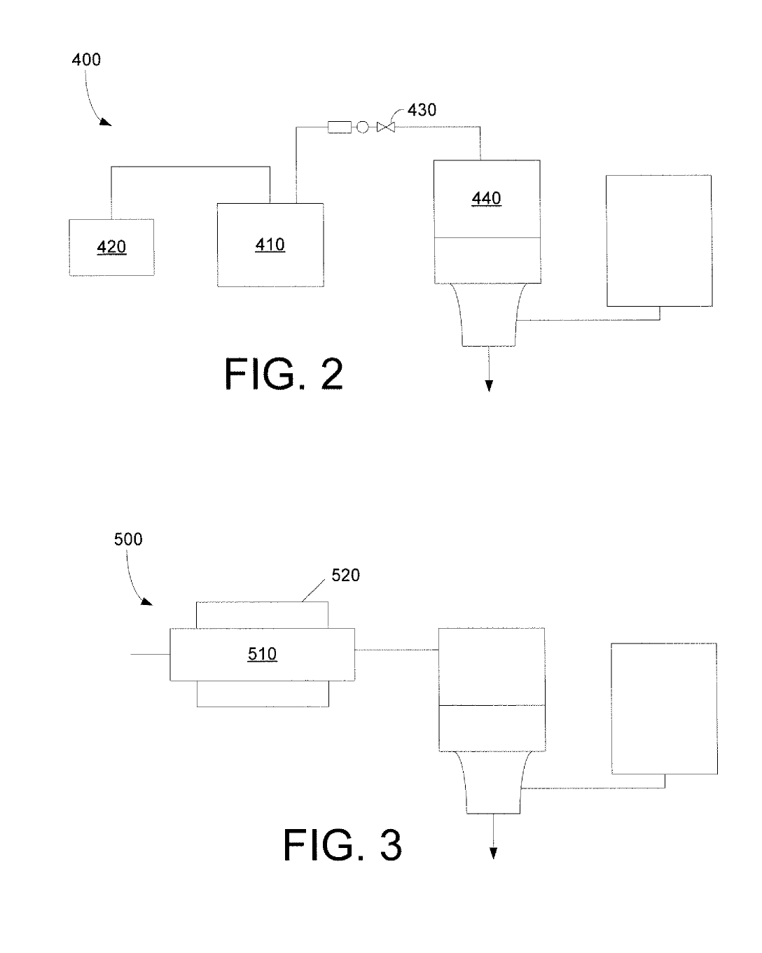

Referring now to the drawings, in which like numbers refer to like elements, FIG. 1 shows a brewing device 100 as is described herein. The brewing device 100 includes a main boiler 110. The main boiler 110 may be of conventional design. Any device for heating water may be used herein. The main boiler 110 maintains a volume of water at a desired temperature. The main boiler 110 may operate at or about atmospheric pressure. The main boiler 110 may be connected to a water supply via a main boiler pump 120. The main boiler pump 120 may be of conventional design. A solenoid valve 130 and a check valve 140 may be positioned between the main boiler 110 and the main boiler pump 120. In addition to the solenoid valve 130, any type of on/off valve may be used herein. The main boiler 110 also may have a steam discharge outlet 150. Any similar type of boiler components may be used herein.

The brewing device 100 further includes a saturated steam boiler 160. The saturated steam boiler 160 also may be of conventional design. The saturated steam boiler 160 maintains a volume of water at a desired temperature and pressure. As is well known, the pressure and the temperature of saturated steam are closely related. The saturated steam boiler 160 may be fed from a water source via a saturated steam boiler pump 170. The saturated steam boiler pump 170 may be of conventional design. As described above, a solenoid valve 180 and a check valve 190 may be positioned between the pump 170 and the saturated steam boiler 160. Likewise, a steam discharge outlet 200 may be used. Any similar type of boiler components may be used herein. The saturated steam boiler 160 and the main boiler 110 may be connected via a saturated steam boiler outlet 210. A check valve 220 may be positioned thereon.

The brewing device 100 also may include a brew head 230. The brew head 230 may be of conventional design. The brew head 230 may be positioned about a tealeaf receptacle 240. The tealeaf receptacle 240 includes an amount of tea leaves or amounts of similar materials. The brew head 230 is connected to the main boiler 110 via a main boiler outlet 250. A solenoid valve 260, a flow meter 270, and a temperature gauge 280 may be positioned on the main boiler outlet 250. Similar types of boiler components may be used herein. The brew head 230 also may be connected to the saturated steam boiler 160 by a presoak saturated steam outlet 290. A solenoid valve 300 may be used thereon. Other types of on/off valves or similar types of components may be used herein. A tea collection nozzle 310 may be positioned beneath the tealeaf receptacle 240. The brewed concentrated tea may stream therethrough.

The brewing device 100 also may include a make up water system 320. The make up water system 320 may include a water tank 330. Cool water may be stored within the water tank 330. The water tank 330 may be in communication with the tea collection nozzle 310. A solenoid valve 340 may be used thereon. Other types of on/off valves or similar types of components may be used herein. The make up water system 320 provides a predetermined amount of cool water to the brewed tea concentrate. The make up water also quenches the brewed concentrated tea in the tea collection nozzle 310 so as to ensure that the brewed tea remains a liquid as opposed to steam.

A control 350 may monitor the pressure and temperature of the boilers 110, 160, and operate the solenoid valves as may be desired. The control 350 may be a conventional microprocessor or the like.

In use, the boilers 110, 160 may be set to their desired pressure and temperature. The main boiler 110 may have a temperature of about 200 to about 300 degrees Fahrenheit (about 93 to about 149 degrees Celsius). The main boiler 110 may be kept at about atmospheric pressure. The saturated steam boiler 160 may be set at the desired pressure. The pressure may range from about thirty (30) to about seventy-five (75) pounds per square inch (about two (2) to about five (5) bar). As described above, the temperature of the saturated steam is directly related to the pressure.

Saturated steam from the saturated steam boiler 160 is fed into the main boiler 110 via the saturated steam outlet 210. The pressurized saturated steam acts as a propellant that drives the water in the main boiler 110 towards the brew head 230 under pressure. After the water passes through the tea receptacle, the brewed tea generally will be concentrated, i.e., the tea must be diluted with a volume of water. In this case, the concentrations can run from about eight (8) to one (1) to about fifteen (15) to one (1) or higher. The saturated steam boiler 160 also is directly connected to the brew head 230 in order to provide a steam presoak to the tea leaves within the tea receptacle 240.

By way of example, the main boiler 110 may be set at about 210 degrees Fahrenheit (about 98.9 degrees Celsius). The saturated steam boiler 160 may be set at about 75 pounds per square inch (about 5.2 bar) (and hence, a temperature of about 307.6 degrees Fahrenheit) (about 153.1 degrees Celsius)). About seven (7) grams of tea leaves may be placed in the tea receptacle 240 in order to produce about 100 milliliters of tea concentrate. Any desired amount of tea leaves or other substances may be used herein. The saturated steam from saturated steam boiler 160 may be used to presoak the tea leaves. The saturated steam from the saturated steam boiler 160 then may be released into main boiler 110 such that the water in the main boiler 110 is forced under pressure to the brew head 230. The water will pass through the receptacle 240 and produce the 100 milliliters of tea in about 10 seconds or so. The tea may be concentrated at about ten to one (10 to 1) or higher. By way of comparison, brewing the same amount of tea at the same temperature but at atmospheric pressure would result in a concentration of only about four to one (4 to 1) and would take more time.

The brewing device 100 described herein thus provides the ability to control the temperature and pressure of the brew water independently from one another. In addition to the use of the two (2) boilers 110, 160, however, any device that can control independently both pressure and temperature may be used herein.

For example, a system 400 may use a single boiler 410. The boiler 410 may be fed via a pump 420. A throttle valve 430 or a similar device may be positioned between the boiler 410 and the brew head 440. The pump 420 delivers the water to the boiler 410 at the desired pressure where it is heated before progressing to the brew head 440. The boiler 410 controls the temperature of the water while the pump 420 and the throttle valve 430 control the pressure delivered to the brew head 440.

A similar system 500 is shown in FIG. 3. Instead of the use of a boiler and a pump, a positive displacement pump 510 may be used. The positive displacement pump 510 may be surrounded by a number of wrap heaters 520 or similar types of devices. The use of the positive displacement pump 510 ensures the use of a consistent amount of water at a consistent pump pressure. The wrap heaters 520 heat the water while within the pump 510. Alternatively, the water could be heated in a second step that is separate from the pump 510.

The methods described herein thus provide high volumes of fresh brewed tea concentrate in a fast and efficient manner. The methods described herein essentially continually brew tea concentrate as desired. For example, a gallon of tea similarly may be brewed in less than about one (1) minute. Another benefit of the high concentration ratio is that the tea will quickly cool when cold dilution water is added. As such, the methods described herein are well suited to make large quantities of iced tea in a small amount of time.

It should be apparent that the foregoing relates only to certain embodiments of the present applicant and that numerous changes and modifications may be made herein by one of ordinary skill in the art without departing from the general spirit and scope of the invention as defined by the following claims and the equivalents thereof.

We claim:

1. A method of heating an amount of material positioned within a receptacle, comprising:
heating a first volume of water to a predetermined temperature;
pressurizing a first volume of steam to a predetermined pressure;
releasing the first volume of steam towards the first volume of water so as to force the first volume of water into the receptacle; and
heating the material within the receptacle.

2. The method of claim 1>wherein the predetermined temperature comprises about 200 to about 225 degrees Fahrenheit (about 93 to about 107 degrees Celsius).

3. The method of claim 1, wherein the predetermined pressure comprises up to about 75 pounds per square inch (about 5.2 bar).

4. The method of claim 1, wherein the step of heating the material comprises about ten (10) to about (15) seconds.

5. The method of claim 1, wherein the step of pressurizing the first volume of steam comprises saturated steam.

6. The method of claim 1, wherein the material comprises tea leaves.

7. The method of claim 6, wherein about seven (7) grams of tea leaves are used so as to produce about one hundred (100) milliliters of tea.

8. The method of claim 6, wherein the step of heating the material comprises brewing the tea leaves to a dilution ratio of about eight (8) to one (1) to about fifteen (15) to one (1).

9. The method of claim 8, further comprising adding dilution water to the tea.

10. The method of claim 6, further comprising presoaking the tea leaves with saturated steam.

11. The method of claim 1, wherein the step of releasing the first volume of steam towards the first volume of water so as to force the first volume of water into the receptacle comprising forcing the first volume of water into the receptacle without reducing the temperature of the first volume of water.

12. A method of brewing tea leaves with a volume of water, comprising:
warming the water to about 200 to about 225 degrees Fahrenheit (about 93 to about 107 degrees Celsius);
forcing the water to the tea leaves at a pressure of up to about 75 pounds per square inch (about 5.2 bar); and
brewing the tea leaves for about ten (10) to about (15) seconds.

13. The method of claim 12, wherein the step of forcing the water comprises providing saturated steam.

14. The method of claim 12, wherein about seven (7) grams of tea leaves are used so as to produce about one hundred (100) milliliters of tea.

15. The method of claim 12, wherein the step of brewing the tea leaves results in tea comprising a dilution ratio of about eight (8) to one (1) to about fifteen (15) to one (1).

16. The method of claim 15, further comprising adding dilution water to the tea.

17. The method of claim 12, wherein the step of forcing the water comprises pumping the water.

18. The method of claim 12, wherein the step of forcing the water comprises pumping the water with a positive displacement pump.

19. The method of claim 12, wherein the step of forcing the water to the tea leaves comprising forcing the water to the tea leaves without reducing the temperature of water.

20. A method of brewing an amount of tea leaves positioned within a tea receptacle, comprising:
heating a first volume of water to about 210 degrees Fahrenheit (about 99 degrees Celsius);
pressurizing a first volume of saturated steam to about 75 pounds per square inch (about 5.2 bar);
releasing the first volume of saturated steam towards the first volume of water so as to force the first volume of water into the tea receptacle; and
brewing the tea leaves within the tea receptacle for about ten (10) to about fifteen (15) seconds so as to produce tea with a dilution level of more than about eight (8) to one (1).

21. A method of providing fresh brewed iced tea on demand, comprising: providing hot water to a brew head;
brewing tea to a concentration of at least eight (8) to one (1);
immediately adding cool water to dilute the concentration; and
serving the tea. 22. The method of claim 21, wherein the hot water comprises a temperature of less than about 100 degrees Celsius.

23. The method of claim 21, further comprising the step of adding ice to the tea.

24. The method of claim 21, further comprising the step of providing steam to the brew head.

25. The method of claim 24, farther comprising the step of providing pressurized steam to the brew head.
